(19) United States
(12) Patent Application Publication
(10) Pub. No.: US 2018/0303077 A1
(43) Pub. Date: Oct. 25, 2018

(54) LOBSTER TRAP

(71) Applicant: Scott Warrren DAUPHINEE, Yarmouth (CA)

(72) Inventor: Scott Warrren DAUPHINEE, Yarmouth (CA)

(21) Appl. No.: 15/957,268

(22) Filed: Apr. 19, 2018

(30) Foreign Application Priority Data
Apr. 20, 2017 (CA) 2964816

(51) Int. Cl. A01K 69/08

(52) U.S. Cl. CPC A01K 69/08

(57) ABSTRACT

A lobster trap comprising a base panel, two side panels, two end panels, and a top panel defining therein an interior chamber is described. The components of the trap may be primarily or completely made of a plastic material, which increases durability and longevity of the trap. The top panel may have a smaller area than the base panel, and the side panels and/or the end panels are angled inward forming a trap having a substantially trapezoidal prism shape or a pyramidal frustum shape. The trap is shaped and configured to facilitate vertical stacking, and preferably to allow stacked traps to engage with and interlock with each other. The base panel of the trap may have a support member located along the base panel. The support member is at least partially hollow defining an internal compartment, and the compartment is able to receive weight elements that help to stabilize the trap during and after deployment into the ocean.

### FIELD OF THE INVENTION

The invention relates to a lobster trap, and more particularly, to a lobster trap that facilitates setting, retrieval, ease of use, and storage thereof.

### BACKGROUND OF THE INVENTION

Although lobster has served as a food source for an extended period of time, it was originally consumed by the poor, servants, and prison inmates. There was eventually an increase in the appeal of lobster from both from a culinary and social perspective. Correspondingly, commercial lobster fisheries flourished.

Lobster fishing typically consists of baiting a lobster trap and deploying the trap into seawater. On the ocean floor, the lobster senses the bait, enters the trap, and is typically unable to escape. The trap is ultimately retrieved by the fisherman. Any lobsters that have been trapped inside are kept if they meet certain criteria that are often established by a governing body. Lobster that do not meet these criteria and/or other sea creatures caught in the trap are returned to the ocean. The trap can either be baited again and redeployed, or is stacked back on the ship.

Multiple traps are often deployed together as “strings” or “trolls” where they are interconnected via a rope or the like. Anchors are often utilized to weight the strings to the ocean floor and minimize drifting of the traps. A buoy or similar floatation member is often attached to one or both ends and/or a midpoint of the rope to aid in locating and retrieving the string of traps.

The lobster trap has changed very little over the years. Traps were traditionally made of wood, and contained a tapered entrance to ideally permit a unilateral entrance of lobsters into the trap. Traps contained multiple chambers, often termed the “kitchen” and “parlour”. When a lobster progresses into these further chambers, they must then traverse additional barriers to escape the trap. Rocks and/or bags of sand were often used to increase the weight of the trap, which affects the rate that the traps sink in water, and encourages the trap to land on the ocean floor in the correct orientation. As traps evolved, they were often constructed with wire mesh or plastic coated wire mesh to extend their lifespan.

The lobster trap art is extensive, and there are a large number of patent documents directed to this subject matter. Some exemplary patent documents are discussed below.

U.S. Pat. No. 3,826,032 teaches combining plastic wall segments to form a substantially rectangularly shaped trap. There are entrances on both opposing sides of the trap, and an interior frame that separates the antechamber from the parlour section. There is a door on the top of the trap to allow removal of the product.

U.S. Pat. No. 4,486,973 teaches a shellfish trap comprising a plastic cage section hingedly attached to a base section. The plastic cage comprises an opening to allow shellfish to enter the cage. Concrete weights are integrated into the base section to act as ballast.

U.S. Pat. No. 3,708,905 describes a substantially rectangular lobster trap formed of six plastic panels. There is a conventional entrance on one side, and a panel on the top side of the trap. There are plastic feet or runners on the underside of the trap that serve as ballast boxes, and are filled with rocks or other suitable material.

U.S. Pat. No. 4,711,050 teaches a generally rectangular lobster pot having a hinged door on the top of the trap, and openings on the sides of the trap to allow lobster into the “kitchen”. U.S. Pat. No. 3,497,989 teaches a trap molded from plastic material, which comprises opposing elliptical halves that combine together. There are openings on the sides thereof to facilitate ingress of the lobster. U.S. Pat. No. 5,943,814 teaches a rectangular box-like trap comprising multiple openings and at least one parlour. Runners are attached to the bottom of the trap, and have weights (e.g. concrete) integrated therein.

### SUMMARY OF THE INVENTION

According to an aspect of the present invention, there is provided a lobster trap comprising a base panel, two side panels, two end panels, and a top panel defining therein an interior chamber. Preferably, the components of the trap are primarily or completely made of a plastic material.

In one embodiment, the top panel has a smaller area than the base panel, and the side panels and/or the end panels are angled inward forming a trap having a substantially trapezoidal prism shape or a pyramidal frustum shape.

According to another embodiment, the base panel comprises at least one support member, which is/are preferably located along the base panel to maintain a balanced trap. The support member is at least partially hollow defining an internal compartment, and the compartment is able to receive weight elements.

In yet another embodiment, the trap is shaped and configured to facilitate vertical stacking, and preferably to allow stacked traps to engage with and interlock with each other. The traps may comprise locking members that extend upward and above the plane of the upper face of the frame of the top panel. The locking members can be on the side frames and/or end frames of the top panel, or alternatively, the locking member can be a single projection or ridge that extends upward around the entire upper frame of the top panel.

### BRIEF DESCRIPTION OF THE DRAWINGS

The present invention will now be described in more detail having regard to the drawings in which:

FIG. 1 is an upper perspective view of an embodiment according to the present invention;

FIG. 2 is an extended view of an embodiment according to the present invention;

FIG. 3 is a right side view of the embodiment shown in FIG. 1;

FIG. 4 is a left side view of the embodiment shown in FIG. 1;

FIG. 5 is a top plan view of the embodiment shown in FIG. 1;

FIG. 6 is a bottom view of the embodiment shown in FIG. 1;

FIG. 7 is a front view of the embodiment shown in FIG. 1;

FIG. 8 is a rear view of the embodiment shown in FIG. 1;

FIG. 9 is a magnified extended view of a weighting system according to an embodiment of the present invention;

FIG. 10 is a magnified extended cutaway view of a weighting system according to an embodiment of the present invention, in which a portion of the base panel has been cutaway for illustration purposes;

FIG. 11 is an upper perspective view of an embodiment according to the present invention, in which the doors are in an open position;

FIG. 12 is a rear cutaway view of an embodiment according to the present invention, in which the mesh of the rear end panel has been cutaway for illustration purposes;

FIG. 13 is a magnified view of a hinge according to an embodiment of the present invention;

FIG. 14 is a magnified view of a hinge according to an embodiment of the present invention, in which the end frame member of the top panel is shown as transparent to facilitate viewing of the hinge;

FIG. 15 is a front perspective view of an embodiment according to the present invention, in which multiple hinge types are shown;

FIG. 16 is a magnified view of the right hinge as shown in FIG. 15, with the door in a partially open position;

FIG. 17 is a partial upper perspective view of an embodiment according to the present invention;

FIG. 18 is a magnified perspective view of the underside of a door of a trap according to the present invention;

FIG. 19 is a magnified view of an escape opening according to an embodiment of the present invention, in which a plurality of escape vents is shown;

FIG. 20 is a magnified perspective view showing the interaction between stacking traps according to an embodiment of the present invention, in which a portion of the upper trap has been cutaway for illustration purposes;

FIG. 21 is a perspective view of a trap in which the internal compartments are arranged according to an embodiment of the present invention;

FIG. 22 is a perspective view of a trap in which the internal compartments are arranged according to another embodiment of the present invention;

FIG. 23 is a perspective view of a trap in which the internal compartments are arranged according to a further embodiment of the present invention; and

FIG. 24 is a perspective view of a plurality of traps shown in a stacked relationship.

### DETAILED DESCRIPTION OF THE INVENTION

A better understanding of the present invention and its objects and advantages will become apparent to those skilled in this art from the following detailed description, wherein there is described only the preferred embodiment of the invention, simply by way of illustration of the best mode(s) contemplated for carrying out the invention. As will be realized, the invention is capable of modifications in various obvious respects, all without departing from the scope and spirit of the invention. Accordingly, the description should be regarded as illustrative in nature and not as restrictive.

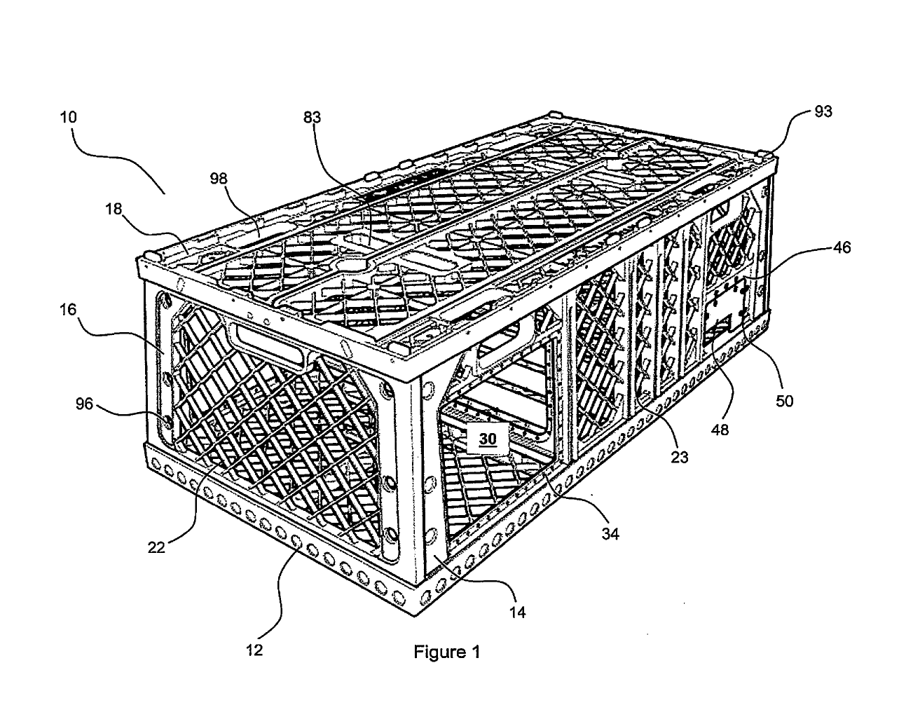

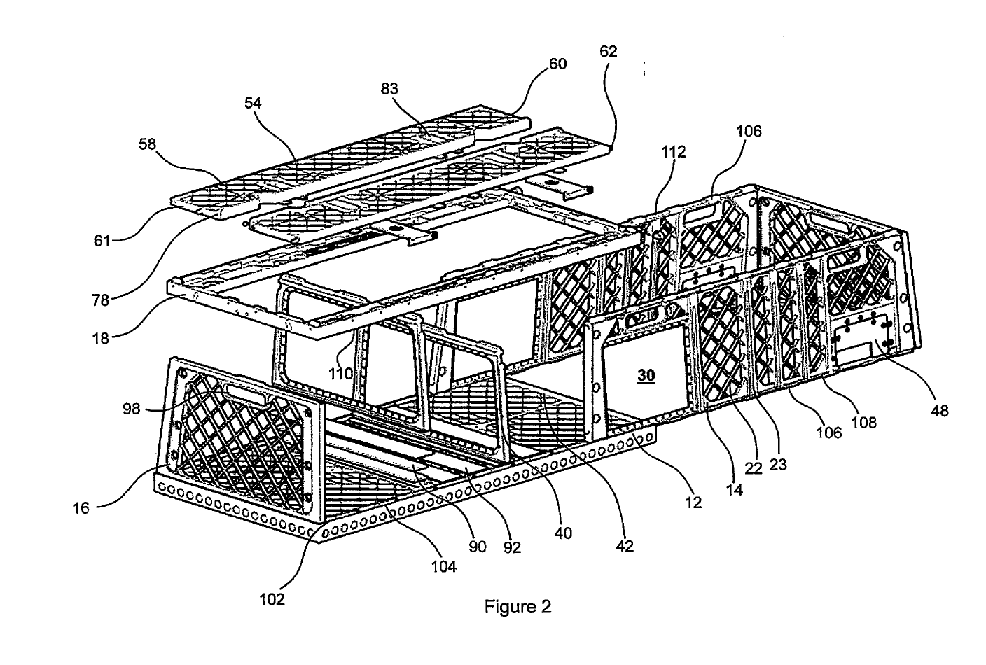

FIGS. 1 and 2 illustrate a lobster pot or trap 10 according to an exemplary embodiment of the present invention. The trap 10 comprises a base panel 12, two side panels 14, two end panels 16, and a top panel 18 defining therein an interior chamber 20. Each panel comprises a frame member and a sturdy material, which may be interlaced, extending between the frame member thereof having holes therethrough that essentially define a mesh 22. In the illustrated embodiment, the base panel 12 and the top panel 18 are substantially rectangular in nature, although other shapes are contemplated, and are substantially parallel to each other. When the top and base panels 18, 12 are interconnected by the side and end panels 14, 16, the trap 10 forms a substantially rectangular parallelepiped. While this shape is common for lobster traps, other shapes, are also contemplated.

However, in a preferred embodiment, the top panel 18 has a smaller area than the base panel 12. The top panel 18 can have a shorter width, a shorter length, or both a shorter width and length than the base panel 12. In order to interconnect the base panel 12 and top panel 18, the side panels 14 and/or the end panels 16 are angled inward forming a trap 10 having a substantially trapezoidal prism shape or a pyramidal frustum shape (See FIGS. 1, 3, and 7). Such a shape tends to distribute more weight to the base panel 12 of the trap 10, which serves to lower the center of gravity of the trap 10, and facilitates righting of the trap 10 when it is deployed into the water and provides additional stability when the trap 10 is on the ocean floor.

Certain government agencies regulate size requirements that lobster traps must meet, which may vary across countries. Accordingly, the size of the trap 10 is not particularly limiting, and traps 10 having a plurality of sizes and dimensions can be manufactured to accommodate the regional requirements.

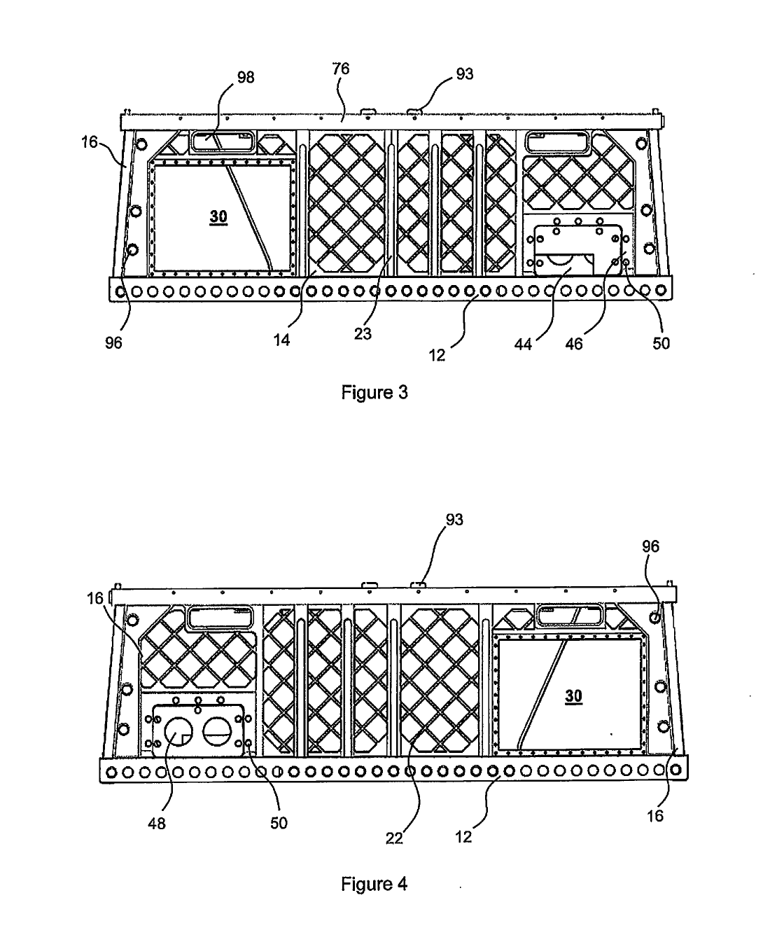

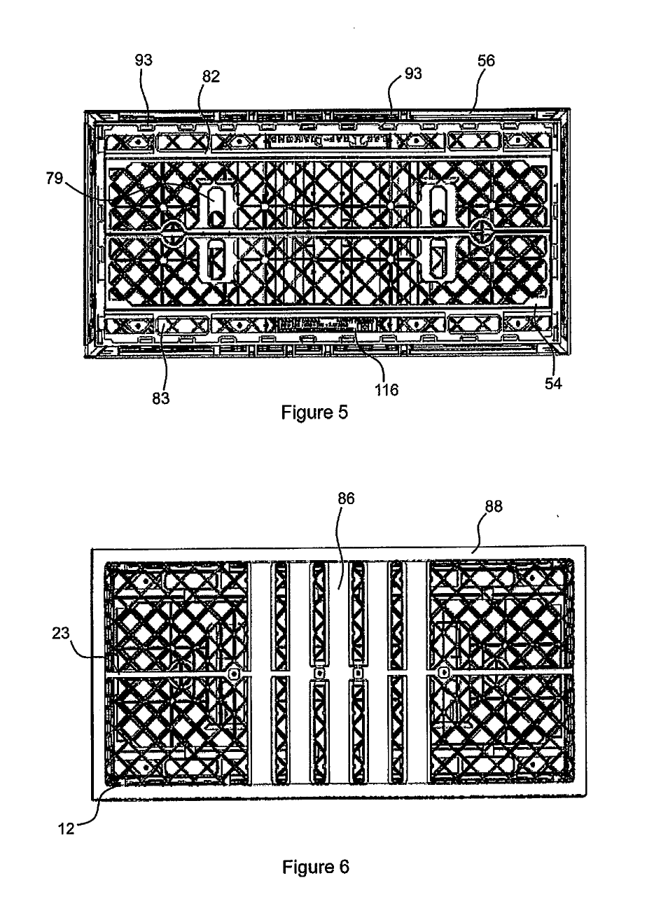

The mesh 22 serves to contain trapped lobsters within the trap 10. The design and pattern of the mesh 22 can impact certain factors that affect the function of the trap 10, such as increasing or decreasing drag. Drag influences how quickly a deployed trap 10 sinks, how easily a trap 10 on the ocean floor is affected by currents, tides, etc., how much effort is needed to retrieve a trap 10 from the ocean floor, just to name a few. The design and pattern of the mesh 22 also affects the overall weight of the trap 10. The mesh 22 pattern may include e.g. square, rectangle, circular, oblong shapes, diamond, hexagonal, honeycomb, irregular shapes, or any combination of these. The pattern may also include other shapes while falling within the scope of the present invention. Additionally, the mesh 22 may be reinforced with support members 23 (see e.g. FIGS. 2 and 3) that aid in strengthening the trap.

According to a preferred embodiment of the invention, the components of the trap 10 are primarily or completely made of a plastic material. Utilizing a plastic material in at least some of the structure of the trap 10 reduces overall weight of the trap 10, increases durability, and extends lifespan of the trap 10, particularly when compared to traditional wood, metal and/or coated metal traps. The plastic material may include, for example, polypropylene, high density polyethylene, low density polyethylene, polyethylene terephthalate, acrylonitrile butadiene styrene, polyvinyl chloride, polycarbonate, fiber reinforced plastics, and acetals, just to name a few, although other suitable plastics known to one of skill in the art are also contemplated. Utilizing a plastic material that has a higher specific gravity than seawater is preferred, although with those plastics having a lower specific gravity than seawater can be employed to assist in weighting the trap 10 to facilitate e.g. sinking after deployment.

According to another embodiment, the trap 10 is made of a hybrid of materials. For example, the mesh 22 portions of the panels may be made of a plastic material, and the frame members of the panels may be made of a separate material, such as metal, wood, or plastic coated metal.

When not in use, traps 10 are often stored outside and must weather exposure to the elements. According to one embodiment, the plastic material contains an ultraviolet inhibitor and/or ultraviolet stabilizer. Inclusion of such a compound may inhibit, delay or minimize degradation of the plastic material that can be realized through long-term exposure to the sun. Ultraviolet inhibitors and/or stabilizers known in the art can be utilized in the plastic material according to the invention. Various additives that would be known to one of skill in the art can also be added to the plastic material to produce a variety of different colours.

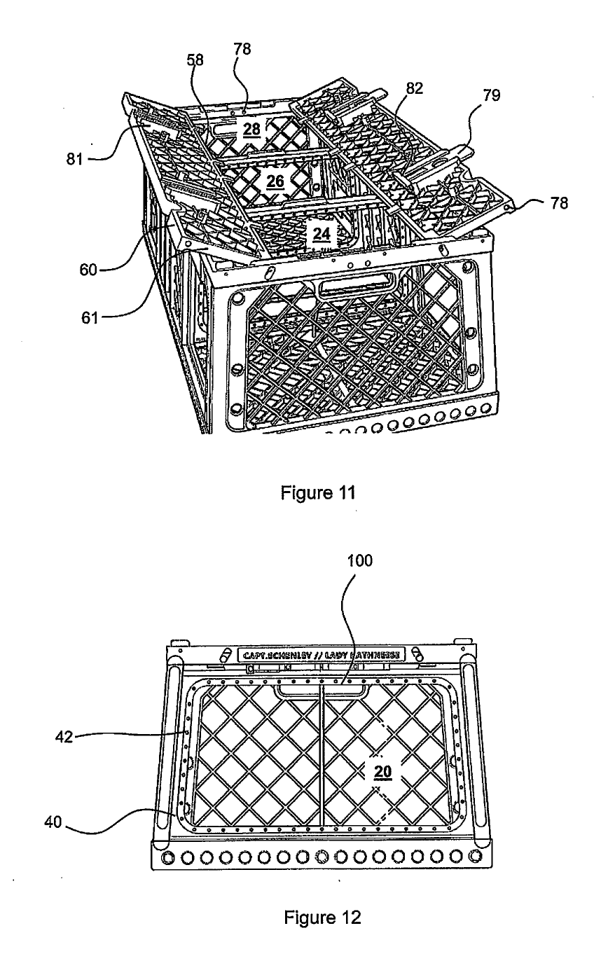

The trap 10 is preferably constructed to be compartmentalized into two or more areas (see FIGS. 1 and 11). The first area 24, often referred to in the art as the “kitchen”, is accessed through an opening or entrance 30 in at least one of he side and/or end panels 14,16 to allow the lobster to enter the trap 10. Once in the first area 24, the lobster may then travel into a second area 26, often referred to in the art as the “parlour”. Once lobsters travel to this second area 26, the difficulty of egress from the trap 10 is compounded. In one embodiment, the trap 10 has a third area 28 at the end of the trap 10 opposing the first area 24, which serves as a second “parlour” or a “jail” as known in the art. The areas can be of about equivalent sizes, or the sizes of the areas can vary with relation to each other.

The trap 10 is constructed with at least one entrance 30. Preferably there are two entrances 30 on the trap 10 found on opposing side panels 14, which allow lobsters to enter the first area 24 of the trap 10. It is also possible for the trap 10 to have three entrances 30, where the third entrance 30 is found on an end panel 16 leading into the first area 24 of the trap 10. Additional entrances, including entrances that lead directly into second and/or third areas are also contemplated.

In one embodiment shown in FIG. 1, at least one side panel 14 is manufactured with a void in the mesh 22 to serve as the entrance 30. When in use, an ingress device (not shown to increase clarity), such as netting, or a funnel etc. is attached at the entrance 30 of the trap 10. The ingress device extends transversely inward, and functions essentially as a typically unidirectional entranceway to direct the lobster into the first area 24 or kitchen. The particular type of ingress device is not particularly limiting to the invention, and can be selected and installed by the end user after the trap 10 has been manufactured according to their needs, desires and preferences. In order to accommodate the possible attachment of a range of different ingress devices, around the perimeter of the entrance 30 there are preferably ingress device securing means 34, such as apertures to allow for the securing of netting via e.g rope or twine, snap-fit or press fit means to secure the attachment of a molded funnel, etc. Alternatively, the ingress device can be secured to the trap 10 by way of e.g. an adhesive or other fastener.

In an embodiment of the invention that comprises two distinct areas in the interior chamber 20, when the trap 10 is ready for use, the first area 24 is physically separated from the second area 26 by way of a second ingress device (not shown to increase clarity). The second ingress device, such as netting, or a funnel etc. is attached to the trap 10 and serves as essentially a unidirectional device to transition and direct the lobster from the first area or kitchen 24 to the second area or parlour 26.

In an embodiment of the invention that comprises three distinct areas in the interior chamber 20, when the trap 10 is ready for use, the first area 24 is physically separated from the second area 26 by way of a third ingress device (not shown to increase clarity). The third ingress device, such as netting, or a funnel etc. is attached to the trap 10 and serves as essentially a unidirectional device to transition and direct the lobster from the second area or first parlour 26 to the third area or second parlour 28.

The particular type of second and/or third ingress devices are not particularly limiting to the invention, and can be selected and installed by the end user after the trap 10 has been manufactured according to their needs, desires and preferences.

In order to accommodate the possible attachment of a range of different types of second/third ingress devices, there may be means on the interior of the trap 10, such as on the insider of the support member 23, to secure the second/third ingress devices, such as apertures to allow for the securing of netting via e.g. rope or twine, snap-fit or press fit means to secure the attachment of a molded funnel, etc. Alternatively, the second/third ingress devices can be secured to the trap 10 by e.g. attaching directly to the mesh 22 of the panels by e.g. an adhesive or other fastener (screws, nails, etc.).

In another embodiment, the different areas 24, 26, 28 of the interior 20 of the chamber are defined and delineated by a partition 40. As shown in FIG. 2, the partition 40 is preferably a somewhat rigid frame that mimics the shape of the end panels 16, although slightly smaller in dimension. There may be means to secure the partition 40 in place, such as snap means or latch means, or alternatively, the partition 40 is secured in place be means a snug press fit between the base panel 12, the side panels 14, and/or the top panel 18. In one embodiment, the e.g. side or bottom edges of the partition have protrusions that may have e.g. a dovetail cross-section or other shape, and that are matingly received by a track in the base panel 12, side panels 14, and/or top panel 18 of the trap 10. The partition also serves to reinforce and strengthen the trap 10, including providing additional support for the top panel 18 and/or a door 54. In addition, the partition 40 may provide means 42 to secure the second/third ingress devices. FIG. 12 illustrates apertures to allow for the securing of netting etc., but the partition 40 may also comprise alternative securing means 42, such as snap-fit, press fit, latch means etc. to secure ingress devices between differing areas 24,26,28 of the trap 10.

The partitioning of the trap 10 may take many forms, and may be customizable so that areas of the trap can be easily arranged either by the manufacturer or by the end user according to their needs and preferences. Furthermore, while the areas 24,26,28 are shown in the drawings substantially equivalent in size, other embodiments may have size variations in which e.g. the parlour(s) 26 is/are larger than the kitchen 24.

The embodiment shown in FIG. 1 illustrates a trap 10 with three distinct areas: a first area or kitchen 24 at one end of the trap 10 having an entrance 30, a second area or parlour 26 in the middle of the trap 10, and a third area or second parlour 28 at the second end of the trap 10.

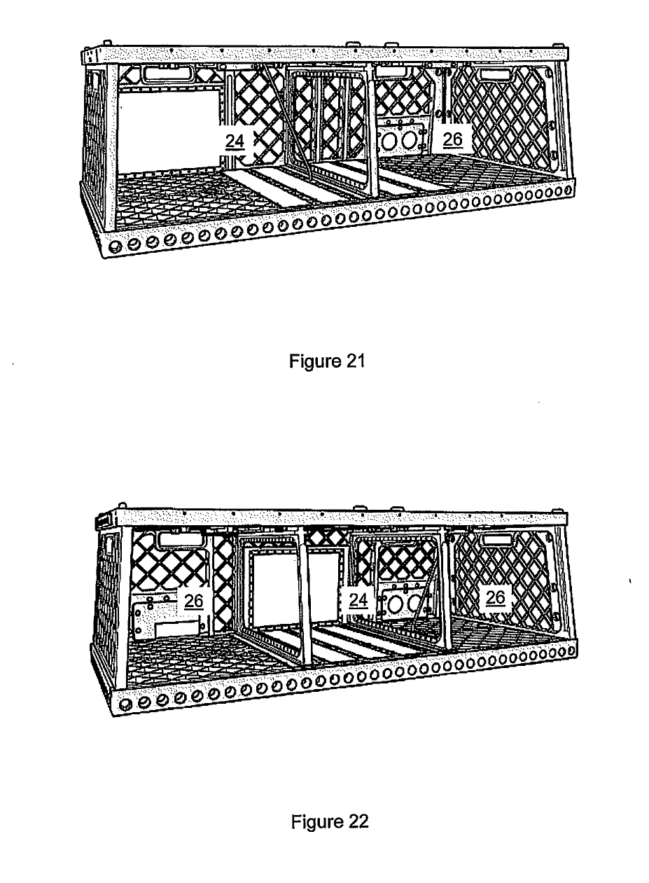

In another embodiment as shown in FIG. 21, the trap 10 comprises a first area or kitchen 24 at one end, and only a single second area or parlour 26 at the opposing end.

A further embodiment shown in FIG. 22 illustrates a trap 10 comprising three distinct areas; however in this embodiment the first area or kitchen 24 is located in the middle area and two distinct parlours 26 are located at opposing ends of the trap 10. Each parlour 26 is in communication with the first area 24, providing multiple optional areas for the lobster to venture once inside the trap 10.

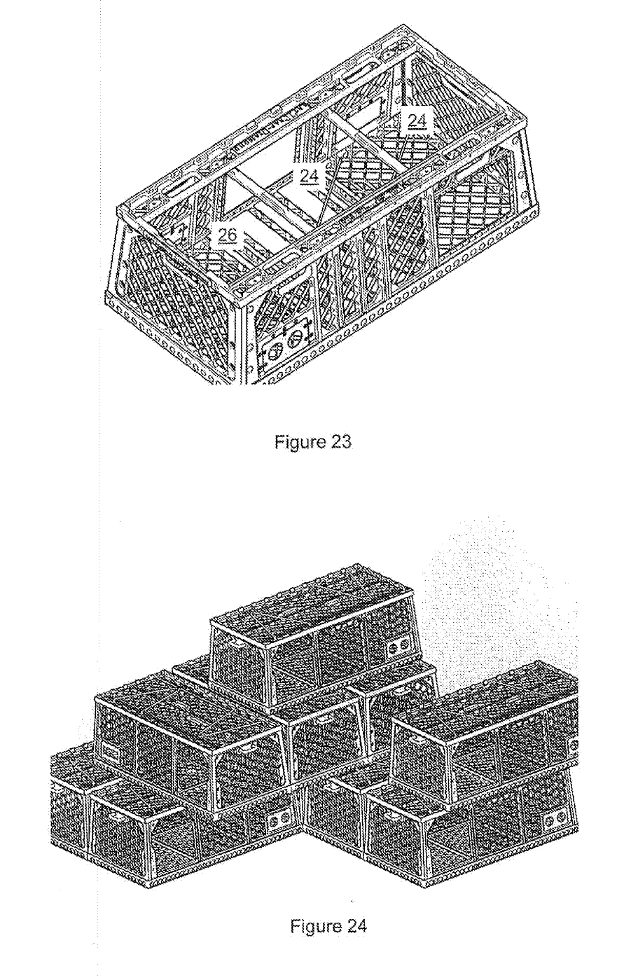

An alternative embodiment shown in FIG. 23 illustrates a trap 10 having three distinct areas, in which two of the areas have entrances 30 and serve as kitchens 24, and the third area serves as a first area or parlour 26. Although this embodiment illustrates the kitchens 24 at an end and the middle of the trap 10, the kitchens 24 could also be at opposing ends of the trap 10, with the parlour 26 in the middle.

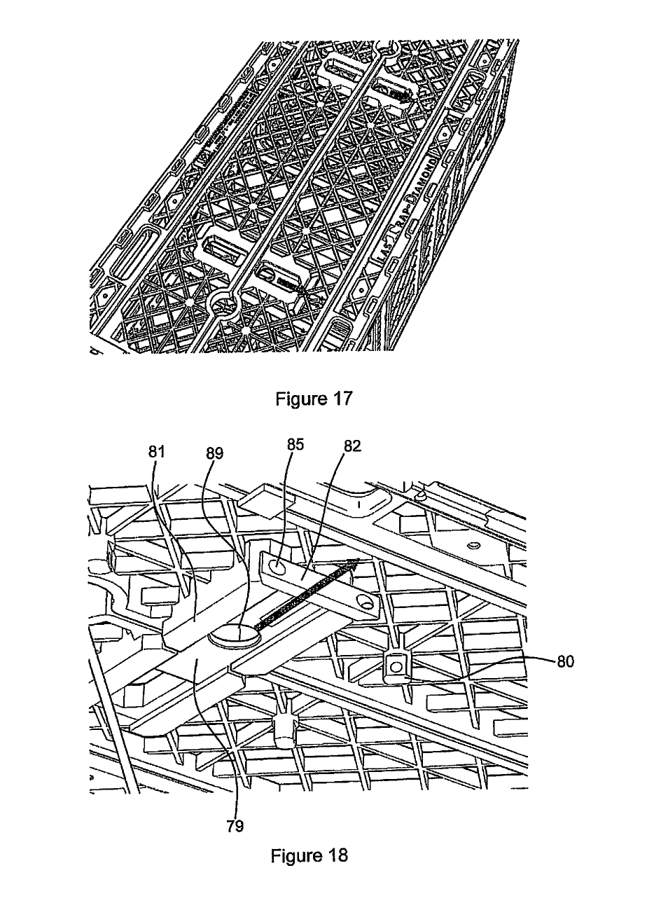

According to one embodiment, the trap 10 comprises an escape opening 44 (see FIGS. 3, 4, and 19). The escape opening 44 allows undersized lobsters, fish, and other sea creatures that are unintentionally caught in the trap 10 to exit. As can be seen in FIG. 17, the escape opening 44 is essentially a framed void in the mesh 22 of the side panel 14, where the escape opening frame 46 is equipped to secure an escape vent 48. For example, known escape vents are often attached and installed in traps 10 through latching, hooking, tying, fastening, etc. The escape opening frame 46 can therefore have escape vent securing means 50 such as apertures, hooks, latches etc. An escape vent 48 can be installed through attachment to the escape opening frame 46 either during the manufacture of the trap 10, or by the end user according to their desired needs, requirements, and preferences.

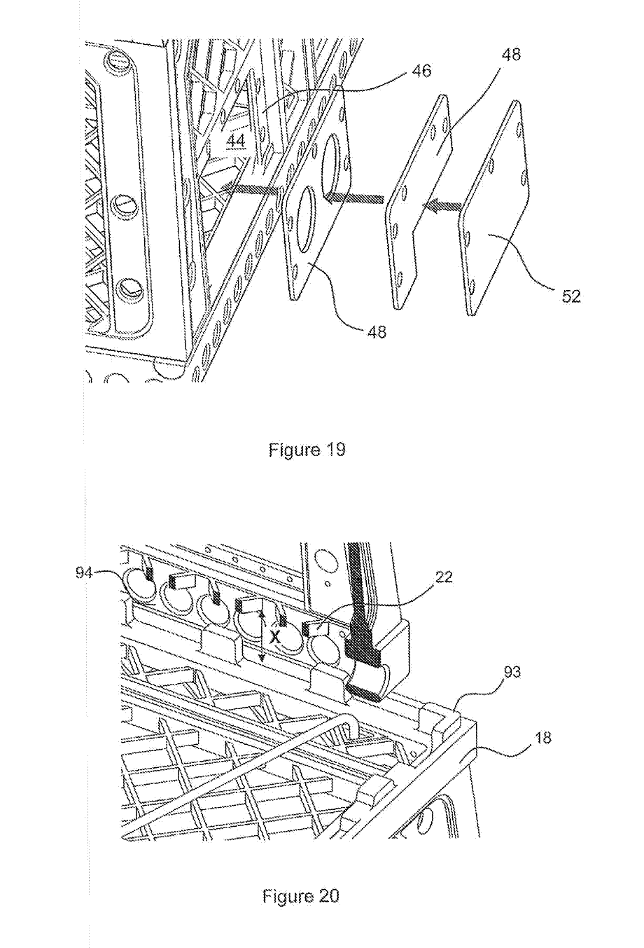

Preferably, the escape opening 44 is located at a position that accesses at least one parlour 26. However, as can be seen from the drawings (see e.g. FIG. 23), the trap 10 may comprise multiple escape openings 44, which may be located at various positions on the trap 10. If certain government regulations only require a single escape opening 44 per trap 10, the end user would then have the option of installing a cover 52 to effectively cap unnecessary escape openings 44 if desired (see e.g. FIG. 19).

Exemplary escape vents 48 are illustrated in FIG. 19 having a rectangular opening, or two smaller circular openings. Other styles of escape vents 48 known to one of skill in the art could also be installed in the trap 10 of the present invention.

While the size and shape of the escape opening 44 is not particularly limiting to the invention, certain governments regulate dimensions and types of escape vents 48 that need to be met. Accordingly, the escape opening 44 is sized and shaped to accommodate escape vents 48 that meet a variety of regulations.

The top panel 18 preferably has a door 54 or multiple doors 54 to provide access to the interior chamber 20 of the trap 10. This allows the user to e.g. bait the trap 10, remove lobsters from the trap 10, make repairs to the trap 10, etc. The door(s) 54 may span only a portion of the top panel 18, or alternatively, may take up substantially the entire top panel 18.

In one embodiment (see FIGS. 1 and 11), the mesh 22 of the top panel 18 and the doors 54 are on a lower plane than the uppermost edge 56 of the frame of the top panel, such that when the doors are in a closed position, they are substantially flush with the mesh 22 of the top panel 18 but below the frame of the top panel. This helps to protect the mesh 22 of the top panel 18 and the doors 54 from damage that may be incurred when the traps 10 are vertically stacked upon each other.

In an embodiment where the trap comprises multiple doors 54, each door 54 has an outer edge 58, an inner edge 60, and side edges 61 (see FIG. 11). In the preferred embodiment as illustrated, the doors 54 span substantially the length of the top panel 18 of the trap 10, but not its width. In other words, the inner edge 60 of the door substantially abuts the mesh 22 of the top panel 18, but in an alternative embodiment, the doors 54 may span the entire width of the trap 10 and substantially abut and/or hinge at the side frame member of the top panel, which would provide a wider opening to access the interior 20 of the trap 10.

In one embodiment, the door(s) 54 preferably has a handle 83 to facilitate grasping and opening of the door(s) 54. The handle 83 may extend outward from the door 54, or may simply be a void (see FIG. 17) that permits the user to grasp the door 54.

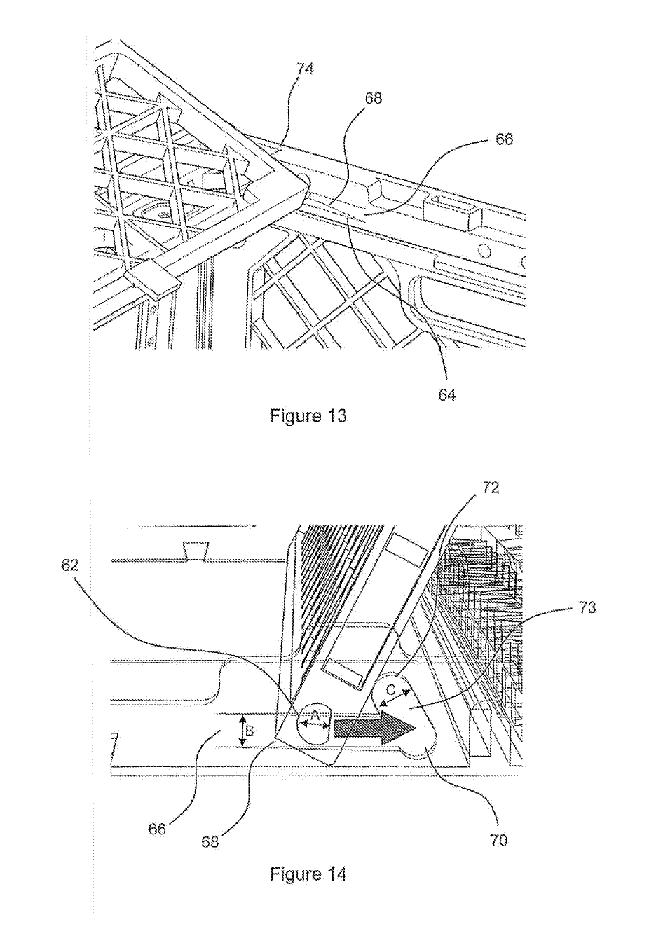

At about the opposing ends of the inner edge 60 of each door 54, there is a hinge peg 62 that extends laterally outward according to an embodiment of the invention (see e.g. FIGS. 13 and 16). In this embodiment, the door(s) 54 can be easily removed from the trap 10, which facilitates simple replacement of the door(s) in the case of damage. The hinge peg 62 on each end of the door 54 engages with a hinge track 64 on the inner face of the end frame members 74 of the top panel. The shape of the hinge track 64 may be linear, or alternatively, the hinge track 64 has the shape of substantially a half arrow as shown in FIGS. 13 and 14. The hinge track 64 has an opening 66, a main channel 68, a seated portion 70, and an elevated portion 72, and a channel 73 connecting the seated and elevated portions 70, 72 (see FIG. 14). As the track 64 progresses from the opening 66 along the main channel 68 to the channel 73, the depth of the track 64 increases, with the channel 73, seated portion 70 and elevated portion 72 preferably having the greatest depth (see FIG. 13). The opening 66 of the hinge track is substantially located toward the midpoint the inner face of the end frame members 74 of the top panel and extends laterally toward the side frame member of the top panel.

When installing the door(s) 54 on a trap 10 according to this embodiment, the hinge pegs 62 on opposing sides of the door 54 are entered into the shallow opening 64 of the hinge track 66. The hinge pegs 62 are slid back along the main portion 68 of the hinge track 66 (see arrow in FIG. 14) until they reach the channel 73, and typically rest in the seated portion 70 of the hinge track 64. The door 54 is now able to be placed in a closed position. The depth of the hinge track 64 limits the ability of the hinge pegs 62 to exit the hinge track 64 when the door 54 is in a closed position. When the door 54 is opened and the hinge pegs 62 remain in the seated position 70 in the hinge track 64, the door 54 may rest against the side frame member of the top panel 76. Such an orientation may limit how wide the door 54 may open. Moving the hinge pegs 62 up the channel 73 into the elevated position 72 raises the door 54 in relation to the side frame members of the top panel 76, and increases the degrees relative to the vertical that the door 54 may open, providing for a more unencumbered access to the interior chamber 20 of the trap 10. Such a design of the door hinge mechanism allows for easy installation and removal of the door(s) 54, and provides variable opening positions.

According to another embodiment, the hinge system provides a further means to secure the door 54 to the trap 10. In this embodiment, at least one of the hinge pegs 62 is not symmetrical or uniform in dimension (see FIG. 19). This lack of uniformity produces a hinge peg 62 having a given cross-sectional measurement that is smaller than other cross-sectional measurements of the hinge peg 62. The height B of the hinge track 64 corresponds with the smaller cross-sectional measurement A of the hinge peg 62, allowing the hinge peg 62 to enter and progress along the hinge track 64 only when the door and corresponding hinge peg 62 are in a certain orientation (see FIG. 16), until the hinge peg 62 enters the channel 73, where the hinge peg 62 is able to rotate to more freely. The channel 73, seated position 70, and elevated position 72, which each have a larger width C than the height B of the hinge track 64, allows for movement and rotation of the hinge peg 62 in multiple orientations. In order to remove the door 54, the hinge peg 62 must again be rotated to a certain position in the channel 73 by movement of the door 54 to align the smaller cross-sectional measurement A of the hinge peg 62 with the height B of the hinge track 64. At substantially that orientation, the hinge peg 62 can enter the channel side of the hinge track 64, and progress along the hinge track 64 until it is released.

When the hinge peg 62 is rotated such that the flat planar surface of the hinge peg 62 is substantially parallel to the length of the hinge track 64, the height A of the hinge peg 62 in that orientation will be smaller than the height B of the hinge track 64, thereby permitting the hinge peg 62 to enter and progress along the hinge track 64 until it reaches the channel 73. The channel 73, including the seated position 70 and the elevated position 72, has a width C that permits free rotation, and movement of the hinge peg 62 along the channel 73. The hinge peg 62 will not be able to re-enter the hinge track 64 from the channel 73 until the hinge peg 62 is rotated back to a position where the flat planar surface of the hinge peg 62 is substantially parallel to the length of the hinge track 64, which effectively secures the hinge peg 62 in the channel 73 until the door 54 is rotated into a predetermined position. For example, in the embodiment of the hinge peg 62 illustrated in FIG. 16, the hinge peg 62 would be free to move along the channel 73, but in the orientation shown, the hinge peg 62 would be unable to enter the hinge track 64.

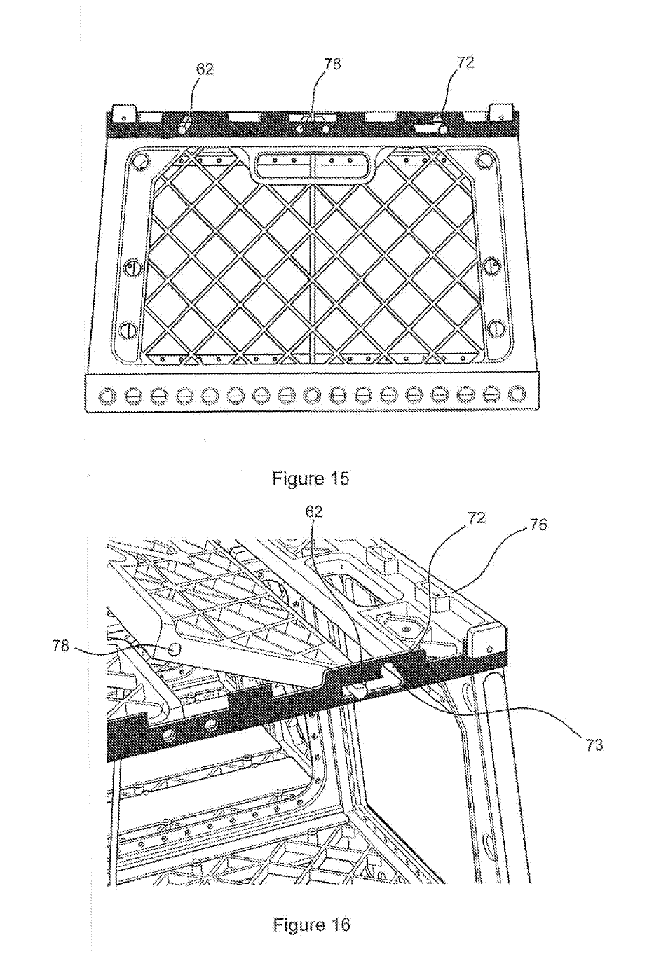

Both ends of the door(s) 54 may have a hinge peg 62 and hinge system as described above and as illustrated in FIG. 16. Alternatively, a first end of the door(s) 54 may have a hinge peg 62 and hinge system as illustrated in FIG. 16, and the second end of the door(s) 54 may have a simple shaped hinge peg 62, such as a cylinder, that matingly fits into a hinge system comprising only a channel 73 with no hinge track 64 (see the left door of FIG. 15). In such an embodiment, the door 54 would be installed by initially inserting the simple shaped hinge peg 62 into the channel 73, and thereafter the opposing hinge peg 62 would be rotated appropriately so that it can enter the hinge track 64 on the opposing end of the upper frame of the trap 10 as discussed above. Alternatively, both ends of the door 54 may have a simple shaped hinge peg 62, such as a cylinder, that matingly fits into a hinge system comprising only a channel 73 with no hinge track 64 (see the left door of FIG. 15).

When a door 54 comprises a hinge system as illustrated in FIG. 16 on both ends, it is possible that the hinge pegs 62 are designed and dimensioned so that the flat planar surfaces of the hinge pegs 62 are offset from each other. In such an embodiment, an installed door 54 will need to rotate to a first position, e.g. 15° above the top plane of the trap 10, to have a first hinge peg 62 enter the first hinge track 64 from the first channel 73, whereas the door will need to rotate to a second position, e.g. 20° above the top plane of the trap 10, to have a second hinge peg 62 enter the second hinge track 64 from the second channel 73. Such an embodiment should minimize both hinge pegs 62 incidentally entering the hinge track 64 when the door 54 is routinely being open and shut, but still retains the ease of removing and replacing the door 54.

It is also contemplated that the width C of the elevated position 72 and/or the seated position 70 is narrower than the width C of the middle of the channel (not shown). In such an embodiment, the hinge peg 62 would be free to rotate and move when in the central region of the channel 73, but forcing the hinge peg 62 into either the elevated position 72 or seated position 70 would secure the hinge peg 62 in one of these areas by e.g. a snug press fit.

Alternatively, the door(s) 54 may be attached to the trap 10 using a hinge mechanism that would be known to one of skill in the art, and may attach directly to the mesh 22 of the top panel 18 or to the side frame member of the top panel 76, particularly if the hinge mechanism is able to increase the degrees of swing of the door(s) 54.

The door(s) 54 comprise securing elements 78 in order to secure the door(s) 54 in a closed position. For example, in an embodiment comprising two doors 54, the outer edge 58 of each door comprises complementary securing elements 78, such that when the doors 54 are closed together in a complementary manner, a protruding element on the outer edge of one door 54 nests within the recessed element on the outer edge of the second door 54. Such securing elements 78 may also be present between side edge(s) of the door 54 and the end frame member of the top panel (see e.g. FIG. 16). Complementary securing elements 78 could be similar to a tongue and groove system, mortise and tenon system, etc. Other alternative securing elements 78 are available to secure the door(s) 54 in a closed position, including a latch system, fastener, dead bolt, etc. It is possible that the door(s) 54 are secured in a closed position by way of a press fit.

Extraneous material can also be used to secure the door(s) 54 in a closed position in addition to or instead of utilizing securing elements. The extraneous material can be, for example a rope, bungee cord, etc. In such an embodiment, the e.g. cord could be criss-crossed across the door(s) 54 thereby limiting the ability of the door(s) 54 to open. It is possible that the trap 10 may have hooks, loops, etc. available to receive and secure the ends of the e.g. cord 80, or alternatively, the e.g. cord 80 could be fed through and attached to the mesh 22 openings in the top, side, and/or end panels 16 as necessary.

In a further embodiment illustrated in FIGS. 17 to 18, a securing element 78 comprising a sliding latch 79 is shown. Each door has a track 81 shaped and dimensioned to house the sliding latch 79, each track 81 having two open ends when the doors 54 are in an open position. When the doors 54 are in the closed position (see FIG. 18) the track 81 from each door 54 aligns. The sliding latch 79 is able to be inserted into an open end of either one of the tracks 81, and is of a sufficient length to enter the track 81 of the opposing door 54, thereby securing the doors 54 together. The user need only slide the latch 79 so that it is removed from the track 81 of at least one of the doors 54 to allow the doors 54 to open.

While the sliding latch 79 may be unattached to either track 81 of the doors 54, in one embodiment the latch 79 is secured to the track 81 on one of the doors 54, which retains the latch 79 to the trap 10. Furthermore, it is preferred that the latch 79 has a stop 82 located at an end thereof. The stop 82 limits how far the latch 79 may slide into the track 81. For example, as can be seen in FIG. 18, the stop 82 may be a piece that transversely abuts an end of the latch 79 and is unable to enter the track 81 once the latch 79 reaches a certain depth in the track 81.

is The sliding latch 79 may also have a mechanism to secure the latch 79 in a locked position. FIG. 18 illustrates apertures 85 in the stop that can accommodate a fastener 87 such as e.g. string, twine, rope, bungee cord, and the like. Once the latch 79 has been moved along the track 81 to a locked position, the fastener 87 can be secured to e.g. the mesh 22 of the door 54 or to securing members 80 integrated into the trap, to limit the movement of the stop 82, thereby retaining the latch 79 in the locked position.

The sliding latch 79 may have a grasping mechanism 89, illustrated in FIGS. 17 to 18 as an aperture that extends therethrough, which would allow a user to slide the latch 79 along the track 81. Alternatively, the latch 79 may have a projection or peg that acts as a handle that would allow for manipulation of the latch 79.

The sliding latch 79 and associated track 81 are illustrated as being on the underside of the doors 54, i.e. inside the trap 10, however, the sliding latch 79 may also be located on the outside of the doors 54 to facilitate easier access. When the sliding latch 79 and associated track 81 are on the underside of the doors 54, the latch 79 can be manipulated by reaching through the mesh 22 of the doors 54. Alternatively, there may be larger openings in the mesh 22 of the doors 54 that facilitates manipulation of the latch 79 (see FIG. 17). Also, there may be only a single securing element 78 of this type in the doors 54 of the trap, or there may be a plurality spaced along the length of the doors 54.

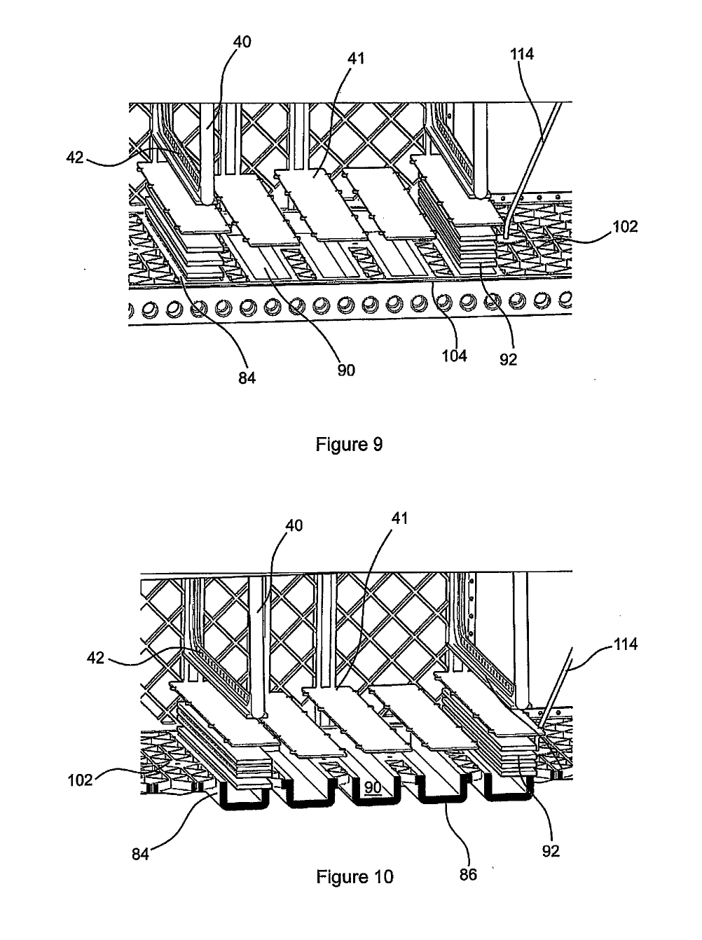

According to a preferred embodiment, the base panel 12 comprises at least one support member 84 (see FIGS. 9 and 10). Preferably the support member(s) 84 are located symmetrically along the base panel 12 to maintain a balanced trap 10. The support member 84 preferably comprises at least one slat that spans the length, width, or otherwise, of the trap 10 as shown in e.g. FIGS. 6 and 9, but other sizes and shapes are contemplated. For example, there may be a series of support members 84 of certain shapes, such as circles, that are positioned at predetermined or random spots along the base panel 12. The outer face 86 of the support member 84 is on a different plane than the mesh 22 of the base panel 12, and is preferably substantially on the same plane as the lower face of the frame member of the base panel 88. It is the support member(s) 84, typically along with the frame members of the base panel 88, which contact the ground when the trap 10 is in an upright position.

In one embodiment as shown in FIGS. 9 and 10, the support member 84 is at least partially hollow defining an internal weight compartment 90. In this embodiment, the internal weight compartment 90 of the support member 84 is accessible, such as from the inside of the trap 10, and is able to receive weight elements 92.

Preferably, access to the internal weight compartment 90 of the support members 84 can be made via a cap 41 or a partition 40 (see FIG. 9), which is seated over the internal weight compartment 90. Once the trap 10 is assembled, the partition 40 is pressed down and secured in position over the top of the support member 84 effectively covering and at least temporarily sealing the compartment 90.

The amount of weight added to the internal weight compartment 90 can vary depending on the requirements and preferences of the end user. To facilitate the addition of different weights to the trap 10, the weight elements 92 themselves can be of varying weights, or alternatively, the internal weight compartment 90 is able to receive a multiple of weight elements 92, where the weight elements 92 can be added or removed as necessary (see FIGS. 9 and 10).

The traps 10 can be manufactured with either some weight elements 92 pre-installed, or with the support members 84 free of weight elements 92. The accessibility of the internal weight compartment(s) 90 allows the end user to manipulate the amount of added weight as is deemed necessary.

The weight elements 92 may be fabricated from cement, sand, rock, steel, brick, metal etc., or any other readily available material that has a reasonable density, and that can be produced in sizes/shapes required to nest in the internal compartment 90 of the support members 84.

Adding additional weight to the base of the trap 10 lowers the center of gravity of the trap 10, which is thought to provide a number of benefits including: keeping the trap 10 in an upright position after it is deployed in the water, allowing the trap 10 to sink at a faster rate, and increasing resistance to tipping, flipping and movement of the trap 10 by tides and currents after it has rested on the ocean floor.

In a preferred embodiment, the trap 10 is shaped and configured to facilitate vertical stacking, and preferably to allow stacked traps 10 to engage with and interlock with each other to enhance stability of stacked traps 10. An exemplary embodiment is illustrated in FIG. 20, where locking members 93 can be seen extending upward and above the plane of the upper face of the frame of the top panel. The locking members 93 can be on the side frames and/or end frames of the top panel, or alternatively, the locking member 93 can be a single projection or ridge that extends upward around the entire upper frame of the top panel.

As described above, a preferred embodiment of the trap 10 has a trapezoidal prism shape or a pyramidal frustum shape, where the top panel 18 has a smaller area than the base panel 12. In such an embodiment, as illustrated in FIG. 20, the mesh 22 that extends between the frame of the base panel is not on the same plane as the lower face of the frame member of the base panel, providing for a space X to receive the locking members 93 of the lower trap 10. Accordingly, when a trap 10 is placed on top of another trap 10, the locking members 93 insert inside the inner face 94 of the frame of the base panel (see FIG. 20). Preferably, the locking members 93 are shaped and positioned to insert inside the inner face of the frame of the base panel, which allows the traps 10 to be effectively interlocked and secured via a snug press fit.

Preferably, the locking members 93 are shaped and positioned to receive and interlock with an upper trap 10 when the traps 10 are in a plurality of positions in relation to each other. For example, it is preferable that the locking members 93 are sufficiently spaced along the frame of the top panel to receive and interlock with an upper trap 10 that is placed on top in a parallel manner or in a transverse manner. Furthermore, as shown in FIG. 19, the locking members 93 are sufficiently spaced and dimensioned along the upper face of the frame such that the top trap can be offset from the lower trap 10, which expands the stacking possibilities of the traps 10. (see FIG. 19). Allowing for stacking of the traps 10 in a crisscross and/or offset pattern should provide for a more stable structure than if traps 10 were simply stacked vertically in parallel, and could provide for a more efficient use of space.

The size, and in particular the girth, of the locking members 93 is not limiting, but they should be of a size that imparts sufficient strength to minimize snapping and/or breaking of the locking member 93. Furthermore, the height of the locking members 93 preferably does not exceed the space X between the lower face of the frame of the base panel and the mesh 22 that extends between the frame of the base panel, as this may negatively affect the stability and strength of the interlocking between the two traps 10.

According to one embodiment, the trap 10 comprises towline attachment points 96. When a trap 10 is deployed, it is attached to a line, such as a rope, in order to allow for subsequent retrieval of the trap 10. The embodiment shown in the Figures illustrates a number of towline attachment points 96 in the form of apertures in the trap 10, particularly in the frame of the side 14 and/or end panels 16, through which the towline can be fed. Other options are contemplated, such as having external metal rings, loops, hooks, etc. that would allow for a towline to be attached to the trap 10. A plurality of towline attachment points 96 is preferred, including at both ends of the trap 10, as it allows the end user to secure the trap 10 to a towline in various ways according to personal preference and/or current conditions (tides, currents etc.).

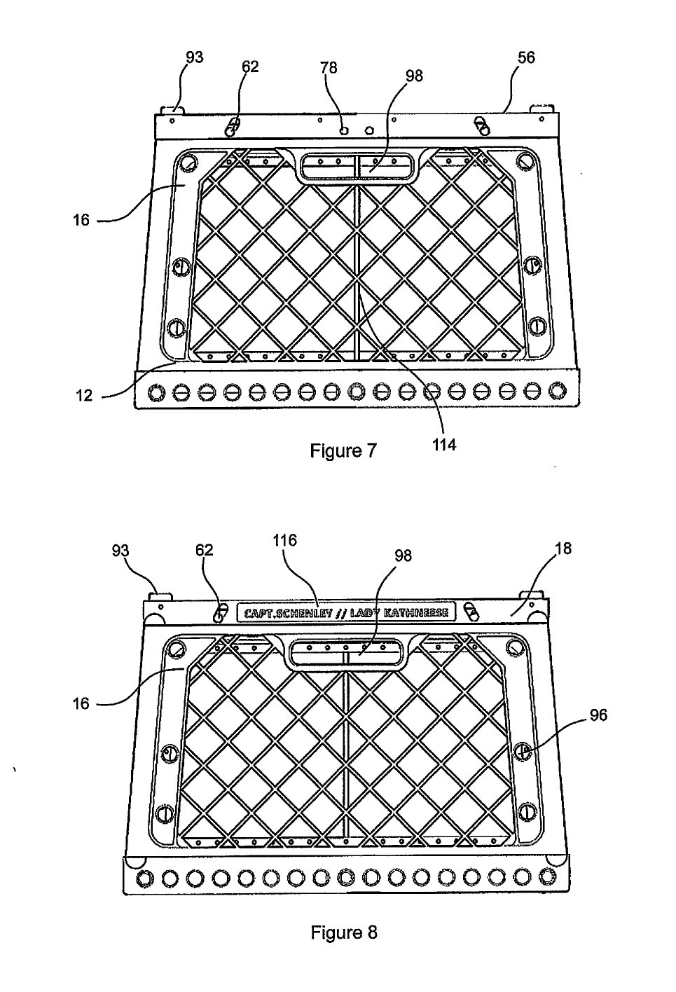

It is preferred that the trap 10 comprise at least one handle 98 to assist the end user in grasping the trap 10 (see FIGS. 7 and 8). The handle 98 may be at least semi-rigid in design, and molded directly to the trap 10. In an alternative embodiment, the handles 98 are integrated into the trap 10 by way of e.g. a molded void, which produces holes that allow grasping of the trap 10. Alternatively, the trap 10 is provided with means for receiving and securing a handle, such as apertures, that are appropriately spaced apart. In such an embodiment, the handle 98 is ideally a pliable handle, such as a rope handle, cable handle, chain handle, etc. Preferably the trap 10 comprises at least two handles 98 and/or means for receiving and securing a handle, which are located on the end panels 16, side panels, top panels, etc. of the trap 10.

The trap 10 may be molded or extruded as a single piece or of different subcombinations thereof. For example, the side panels 14 and end panels 16 could be molded as a single piece, to be subsequently attached to the base panel 12 and top panel 18.

In an alternative embodiment, the trap 10 is modular. Each or most of the pieces of the trap 10 is/are manufactured separately for subsequent assembly. Such an embodiment facilitates manufacturing of the pieces, and the modular nature of the trap 10 also provides interchangeability amongst the parts. For example, the manufacturer or end user is able to disassemble the trap 10 and exchange a broken or damaged part for a new part, thereby increasing the longevity of the trap 10. This would also allow for simpler modification of the partitioning of the trap 10, such as changing a trap 10 from the embodiment shown in FIG. 21 to one shown in FIG. 22 or 23, by substituting out the side and/or end panels 14,16.

In such an embodiment, the pieces are constructed to be interconnectable. Various systems known to one of skill in the art to interconnect the panels of the trap 10 are contemplated within the scope of the invention.

One example is illustrated in FIG. 2, where it can be seen that the upper face of the side frame of the base panel 102 has a track 104 for receiving a projection 106, or a series of shorter projections 106, extending from the bottom face of the bottom frame of a side panel 108. The projections 106 may have a cross section, such as a dovetail, which corresponds to and mates with the track 104 in the base panel 12, to ensure a locked connection. The end panels 16 may attach to the base panel 12 in a similar mechanism. Alternatively, the upper face of the side frame of the base panel 102 may have a series of openings that matingly receive corresponding projections 106 that extend from the bottom face of the frame of a side panel 108. Such an interconnection may be of the snap fit or press fit type.

Similarly, the lower face of the side frame of the top panel 110 may have a track 104 for receiving a projection 106, or a series of shorter projections 106, extending from the top face of the top frame of a side panel 112. The projections 106 may have a cross section, such as a dovetail, which mates with a correspondingly shaped track 104 in the base panel 12, to ensure a locked connection. The end panels 16 may attach to the top panel 18 in a similar mechanism. Alternatively, the lower face of the side frame of the top panel 110 may have a series of openings that matingly receive corresponding projections 106 that extend from the top face of the frame of a side panel 112. Such an interconnection may be of the snap fit or press fit type.

Alternatively, the tracks 104 and/or openings may be present on the side 14 and/or end panels 16, with corresponding projections 106 extending from the base 12 and/or top panel 18. Other systems for interconnecting the pieces of the trap 10 are also contemplated, such as mortise and tenon, tongue and groove, or using an adhesive, just to name a few.

The trap 10 can be fabricated in a plurality of different colours or colour combinations. The entire trap 10 can be a single colour, each modular piece of the trap 10 can be a distinct colour, or any combination thereof. Different colour combinations of traps 10 would help to easily visually distinguish traps 10 from a certain owner when compared to a distinct colour combination utilized by a different owner.

In one embodiment, the trap 10 is manufactured with a bait containment or attachment device 114, which may be located in the first area 24, second area 26, and/or third area 28. Examples of the bait containment or attachment device 114 include e.g. a bait hook, spear, bait column, bait compartment etc. The bait containment or attachment device 114 allows for the trap 10 to relatively secure bait within the trap 10, which is ultimately responsible for luring lobster into the trap 10. The bait containment or attachment device 114 can be of a certain height to nearly or completely abut the doors of the trap 10 when the doors are in a closed position, which serves to prevent or minimize the bait from exiting or sliding off the bait containment or attachment device 114.

Installation of a bait containment or attachment device 114 is optional, and may be left up to the end user to install whichever style of bait containment or attachment device 114 suits their particular needs and preferences. Accordingly, in one embodiment, in lieu of a bait containment or attachment device 114, the trap 10 comprises a bait containment attachment member in the first area 24, such as a loop, hook, latch, aperture, etc., or any other means known for securing bait containment devices 114.

According to another embodiment as shown in FIG. 8, the trap 10 comprises a nameplate 116. The location of the nameplate 116 is not limiting, and is preferably located on the upper and/or lower portion of the trap 10, such as the side panels 14, end panels 16, and/or the top panel 18. The nameplate 116 would allow for imprinting or scribing various text on the traps 10, such as a vessel's name, owner's name, captain's name, etc. This will enhance identification of the trap 10 and specify ownership. Alternatively, this information could be scribed or imprinted directly on the trap 10 in the absence of a specific nameplate. Including such information would obviate the need for attaching extraneous objects (e.g. tags) to the trap 10.

In one embodiment, a serial number allocated to every trap 10 is entered in an electronic database. Certain information particular to that trap can be linked to the serial number, such as owner, fishing vessel captain's name, fishing vessel's name etc., which would allow for expedient identification of a trap 10 if, for example, it became lost. Other information could be linked to the trap through the serial number, including any preferences that the fisherman has, such as colour, netting included or not, name on trap, delivery date and location etc., which would facilitate future orders by the fisherman.

Similarly, the trap 10 can comprise on its surface or on a nameplate 116 the specific brand name of the trap 10, contact information for the distributor and/or manufacturer of the trap 10, or any additional information.

A trap 10 may be equipped with a tracking device, such as a global positioning system (GPS) tracking device that would allow for easier location of traps 10 once they have been deployed in the ocean, or location of traps 10 that have become untethered from their towline and presumed lost. The tracking device would need to be able to withstand exposure to seawater, and pressure changes by virtue of its use in a trap 10. A radio frequency identification (RFID) device could also be affixed to the trap 10 to aid in tracking the device and/or associating information to the trap 10. Alternatively, the trap 10 has a compartment that allows the end user to equip the trap 10 with a tracking device and/or RFID device if desired.

In a further embodiment, at least some of the trap is manufactured out of recycled material. It is envisioned that at the end of the lifespan of a trap 10, the trap could be recycled, and the materials used to produce new traps or other products.

The embodiments of the present invention in which an exclusive property or privilege is claimed are defined as follows:

1. A lobster trap comprising:
a base panel, two side panels, two end panels, and a top panel defining therein an interior chamber, each panel comprising a frame member and an interlaced material extending between the frame member;
wherein at least one of the side panels and the end panels has an entrance opening through which lobster enter the trap;
wherein the top panel has a smaller area than the base panel, and the side panels and/or the end panels are angled inward from the base panel to the top panel, forming the trap into a substantially trapezoidal prism shape or a pyramidal frustum shape.

2. The lobster trap according to claim 1, wherein the base panel comprises support members, the support members having a hollow chamber therein to receive weighted elements.

3. The lobster trap according to claim 1, wherein the support members have a removeable cap that provides access to the chamber.

4. The lobster trap according to claim 1, wherein the top panel comprises locking members extending upward above the uppermost plane of top panel, and wherein the interlaced material in the base panel is recessed inward from the frame thereof to matingly receive the locking members from a second trap positioned underneath.

5. The lobster trap according to claim 1, further comprising a partition positioned substantially vertically inside the trap to section the interior chamber, the partition comprising a partition frame member and ingress device securing means.

6. The lobster trap according to claim 1, wherein at least one of the side panels and the end panels has an escape opening.

7. The lobster trap according to claim 1, wherein the perimeter of the escape opening has escape opening vent securing means.

8. The lobster trap according to claim 1, wherein the top panel comprises two hingedly attached doors.

9. The lobster trap according to claim 1, wherein the doors are attached to the end frames of the top panel.

10. The lobster trap according to claim 1, further comprising a door securing mechanism, the door securing mechanism comprising:
a track on the underside of each of the doors, in which the tracks align when the doors are in a closed position; and
a latch having a length greater than the length of the track, and that is shaped and dimensioned to be slidingly received by the track.

11. The lobster trap according to claim 1, wherein the latch further comprises a stop that limits how far the latch slides into the track.

12. The lobster trap according to claim 1, wherein the latch comprises latch securing means to retain the latch in a locked position.

13. The lobster trap according to claim 1, wherein a plurality of components of the lobster trap comprise a plastic material.

14. The lobster trap according to claim 1, wherein the plastic material is selected from the group consisting of polypropylene, high density polyethylene, low density polyethylene, polyethylene terephthalate, acrylonitrile butadiene styrene, polyvinyl chloride, polycarbonate, fiber reinforced plastics, and acetals.

15. The lobster trap according to claim 1, wherein the plastic material comprises a ultraviolet inhibitor and/or ultraviolet stabilizer.

16. The lobster trap according to claim 1, wherein the interlaced material forms shapes selected from the group consisting of a square, rectangle, circular, oblong shapes, diamond, hexagonal, honeycomb, irregular shapes, and any combination thereof.

17. The lobster trap according to claim 1, wherein the perimeter of the entrance opening has ingress device securing means.

18. The lobster trap according to claim 1, wherein the at least one of the side panels and the end panels has a plurality of entrance openings through which lobster enter the trap.

19. The lobster trap according to claim 1, wherein at least one of the panels comprises towline attachment points.

20. The lobster trap according to claim 1, wherein the trap comprises at least one handle and/or handle attachment means.
